(19) United States
(12) Patent Application Publication
(10) Pub. No.: US 2024/0403937 A1
(43) Pub. Date: Dec. 5, 2024

(54) Transforming Customer Content Data to Anonymized System Metadata via k-Aggregation

(71) Applicant: Microsoft Technology Licensing, LLC, Redmond, WA (US)

(72) Inventor: Brahim BELAOUCHA, Oslo (NO)

(73) Assignee: Microsoft Technology Licensing, LLC, Redmond, WA (US)

(21) Appl. No.: 18/325,629

(22) Filed: May 30, 2023

(51) Int. Cl. G06Q 30/0601; G06F 21/62

(52) U.S. Cl. CPC G06Q 30/0631; G06F 21/6254

(57) ABSTRACT

A method for transforming customer content data to anonymized system metadata includes causing execution of an enterprise application on remote computing systems operated by users associated with multiple enterprises and logging customer content data including data samples corresponding to the users' interactions with the enterprise application. The method includes performing k-aggregation of the data samples by: (a) randomly selecting an enterprise; (b) randomly selecting a user associated with the enterprise; (c) randomly selecting a data sample of the user; (d) repeating (a), (b), and (c) k times, where (a) and (b) are performed without replacement; and aggregating the randomly-requested data samples by position. The method includes repeating the k-aggregation N times with replacement to generate N aggregated data samples, concatenating such data samples to generate an anonymized dataset, training a machine learning model using the anonymized dataset, and deploying the trained machine learning model via the enterprise application.

### BACKGROUND

The present disclosure generally relates to data anonymization. More specifically, the present disclosure relates to the transformation of customer content data to system metadata via a novel k-aggregation data anonymization process.

### SUMMARY

The following presents a simplified summary in order to provide a basic understanding of some aspects described herein. This summary is not an extensive overview of the claimed subject matter. This summary is not intended to identify key or critical elements of the claimed subject matter nor delineate the scope of the claimed subject matter. This summary's sole purpose is to present some concepts of the claimed subject matter in a simplified form as a prelude to the more detailed description that is presented later.

In an embodiment described herein, a method for transforming customer content data to anonymized system metadata is provided. The method is implemented via a computing system including a processor. The method includes causing execution of an enterprise application on remote computing systems operated by users associated with multiple enterprises and logging customer content data including data samples corresponding to each user's interactions with the enterprise application, where the data samples for each user are sorted by position. The method also includes performing k-aggregation of the data samples by: randomly selecting an enterprise from the multiple enterprise; randomly selecting a user associated with the selected enterprise from the users of the remote computing systems; randomly selecting a data sample corresponding to the selected user; repeating the random selection of the enterprise, the random selection of the user, and the random selection of the data sample a first predetermined number (k) of times, where the repetition of the random selection of the enterprise and the random selection of the user is performed without replacement; and aggregating the randomly-requested data samples by position to generate an aggregated data sample. The method further includes repeating the performance of the k-aggregation of the data samples a second predetermined number (N) of times with replacement to generate N aggregated data samples, concatenating the N aggregated data samples to generate an anonymized dataset that is classified as system metadata, training a machine learning model using the anonymized dataset, and deploying the trained machine learning model via the enterprise application.

In another embodiment described herein, an application service provider server is provided. The application service provider server includes a processor, an enterprise application, and a communication connection for connecting remote computing systems to the application service provider server via a network, where the remote computing systems are operated by users associated with multiple enterprises. The application service provider server also includes a computer-readable storage medium operatively coupled to the processor. The computer-readable storage medium includes computer-executable instructions that, when executed by the processor, cause the processor to cause execution of the enterprise application on the remote computing systems and to log customer content data including data samples corresponding to each user's interactions with the enterprise application, where the data samples for each user are sorted by position. The computer-readable storage medium also includes computer-executable instructions that, when executed by the processor, cause the processor to perform k-aggregation of the data samples by: randomly selecting an enterprise from the multiple enterprise; randomly selecting a user associated with the selected enterprise from the users of the remote computing systems; randomly selecting a data sample corresponding to the selected user; repeating the random selection of the enterprise, the random selection of the user, and the random selection of the data sample k times, where the repetition of the random selection of the enterprise and the random selection of the user is performed without replacement; and aggregating the randomly-requested data samples by position to generate an aggregated data sample. The computer-readable storage medium further includes computer-executable instructions that, when executed by the processor, cause the processor to repeat the performance of the k-aggregation of the data samples N times with replacement to generate N aggregated data samples, to concatenate the N aggregated data samples to generate an anonymized dataset that is classified as system metadata, to train a machine learning model using the anonymized dataset, and to deploy the trained machine learning model via the enterprise application.

In another embodiment described herein, a computer-readable storage medium is provided. The computer-readable storage medium includes computer-executable instructions that, when executed by a processor, cause the processor to cause execution of an enterprise application on remote computing systems operated by users associated with multiple enterprises and to log customer content data including data samples corresponding to each user's interactions with the enterprise application, where the data samples for each user are sorted by position. The computer-readable storage medium also includes computer-executable instructions that, when executed by the processor, cause the processor to perform k-aggregation of the data samples by: randomly selecting an enterprise from the multiple enterprise; randomly selecting a user associated with the selected enterprise from the users of the remote computing systems; randomly selecting a data sample corresponding to the selected user; repeating the random selection of the enterprise, the random selection of the user, and the random selection of the data sample k times, where the repetition of the random selection of the enterprise and the random selection of the user is performed without replacement; and aggregating the randomly-requested data samples by position to generate an aggregated data sample. The computer-readable storage medium further includes computer-executable instructions that, when executed by the processor, cause the processor to repeat the performance of the k-aggregation of the data samples N times with replacement to generate N aggregated data samples, to concatenate the N aggregated data samples to generate an anonymized dataset that is classified as system metadata, to train a machine learning model using the anonymized dataset, and to deploy the trained machine learning model via the enterprise application.

### BRIEF DESCRIPTION OF THE DRAWINGS

The following detailed description may be better understood by referencing the accompanying drawings, which contain specific examples of numerous features of the disclosed subject matter.

FIG. 1 is a simplified process flow diagram of a method for utilizing the k-aggregation data anonymization process described herein to generate system metadata suitable for training one or more machine learning models that provide feed ranking and/or content recommendation service(s);

FIG. 2 is a simplified schematic view depicting a process for generating aggregated data samples via k-aggregation;

FIG. 3 is a simplified schematic view depicting a process for generating an anonymized dataset that is classified as system metadata using aggregated data samples generated according to the process of FIG. 2;

FIG. 4 is a process flow diagram of an exemplary method for transforming customer content data to anonymized system metadata according to embodiments described herein;

FIG. 5 is a block diagram of an exemplary computing system for implementing the techniques described herein;

FIG. 6 is a block diagram of an exemplary network environment for implementing the techniques described herein; and

FIG. 7 is a block diagram of an exemplary computer-readable storage medium for implementing the techniques described herein.

### DETAILED DESCRIPTION

Modern enterprise applications enable particular enterprises (e.g., companies or businesses) to perform a wide range of tasks. Such enterprise applications may include, for example, email/communication applications, social networking applications, employee experience applications, calendar applications, word processing applications, spreadsheet applications, and/or presentation applications. Moreover, during the utilization of such enterprise applications, customer content data relating to each enterprise are generally collected and stored. Such customer content data may be used for various purposes, including for training machine learning models that enable such application(s) to provide personalized services (or tools) to enterprise users, such as, for example personalized feed ranking and content recommendation services.

However, in operation, data privacy concerns severely limit the application service provider's ability to utilize such customer content data. In particular, because the datasets are classified as customer content rather than system metadata, the application service provider must account for several privacy requirements when handling the data. In particular, the application service provider must ensure that singling out cannot occur, meaning that it is not possible to isolate some or all records that identify a particular enterprise or individual enterprise user in the dataset. The application service provider must also ensure that there is no linkability between the data, meaning that it is not possible to link data concerning the same subject or the same group of enterprise users. Furthermore, the application service provider must ensure that inference cannot occur, meaning that it is not possible to deduce (with significant probability) the value of an attribute from values of other attributes. Unfortunately, however, customer content in its raw form (i.e., without any anonymization) does not meet any of these privacy requirements. As a result, the machine learning models trained using such customer content data cannot cross regions (meaning that data boundaries are retained between individual enterprise customers) and have low retention periods (since customer content cannot be stored as long as system metadata). Moreover, while various techniques have been developed to anonymize data (e.g., including pseudonymization, noise addition, substitution, k-anonymity, L-diversity, and hashing/tokenization), none of these conventional techniques reliably meet all the aforementioned privacy requirements (i.e., the singling-out, linkability, and inference requirements). In particular, the pseudonymization technique fails to reliably satisfy any of the privacy requirements; the noise addition technique fails to satisfy the singling out requirement; the substitution and hashing/tokenization techniques fail to satisfy the singling out and linkability requirements; the k-anonymity technique fails to satisfy the linkability and inference requirements; and the L-diversity technique fails to satisfy the linkability requirement. Accordingly, there is a need for data anonymization techniques that reliably satisfy all these privacy requirements, thus enabling machine learning models to be trained with high-quality data while still protecting the privacy of customers.

Therefore, the present techniques solve these issues and provide related advantages as well. Specifically, the present techniques provide for the transformation of customer content data to anonymized system metadata that meet the singling-out, linkability, and inference requirements via a novel k-aggregation data anonymization process, which may be performed after data cleaning and outlier detection and correction/removal. In other words, according to embodiments described herein, the k-aggregation data anonymization process is utilized to anonymize cleaned customer content data received from enterprise users corresponding to multiple enterprises during the execution of one or more enterprise applications. Such anonymization effectively alters the classification of such customer content data to system metadata, which can be utilized to train machine learning models that are allowed to cross regions (i.e., boundaries between different enterprises) and have relatively long retention periods. More specifically, the k-aggregation data anonymization process described herein includes randomly aggregating data samples (e.g., customer content numeric values) from k distinct enterprise users and k distinct enterprises and then repeating this k-aggregation N times. This results in the generation of an anonymized dataset that includes the same data features but is classified as system metadata and meets the singling-out, linkability, and inference requirements described above. Moreover, because the resulting anonymized dataset is classified as system metadata, machine learning models trained using the anonymized dataset are also classified as system metadata, thus enabling such machine learning models to cross regions and increasing the retention period for both the dataset and the model(s).

According to embodiments described herein, the generated system metadata may be utilized to train one or more machine learning models for performing enterprise-related tasks, such as, for example, tasks relating to ranking items and/or recommending content to enterprise users across multiple enterprises. As a non-limiting example, assuming that the application service provider is Microsoft Corporation, the application(s) described herein may include (but are not limited to) any or all of the applications within the Microsoft 365® suite. Within the Microsoft 365® suite, there are various surfaces that present the enterprise users with a feed ranking service and/or a content recommendation service, in which each enterprise user is provided with a list of items, files, or other content that are likely to be of interest to the particular enterprise user. Moreover, as enterprise users from multiple enterprises interact with such application(s), Microsoft stores customer content data corresponding to such user interactions. However, because Microsoft must maintain the privacy of each enterprise (and its corresponding enterprise users), Microsoft is unable to effectively train a machine learning model that accounts for the broad range of user interactions across all the enterprises (i.e., across regions). Therefore, the k-aggregation data anonymization techniques described herein are utilized to transform the customer content data to anonymized system metadata, and such system metadata are then used to train one or more machine learning models that are capable of effectively providing feed ranking and/or content recommendation services/tools (and/or other suitable types of services/tools) to enterprise users. (Those skilled in the art will appreciate that Microsoft Corporation and the Microsoft 365® suite are merely mentioned as an exemplary implementation of the present techniques. In practice, the present techniques may be applied within the context of any suitable type(s) of application(s) (or suite(s) of applications) provided by any suitable application service provider, depending on the details of the particular implementation.)

The present techniques provide various advantages over conventional data anonymization techniques and model training techniques. As an example (and as described above), the anonymized system metadata generated according to the present techniques meet all the relevant privacy requirements (i.e., the singling-out, linkability, and inference requirements). As another example, the present techniques produce higher-quality system metadata than conventional data anonymization techniques. In particular, while the conventional k-anonymity process requires data binning with at least k users having the same samples, the present techniques do not require any data binning and, therefore, less information is lost during the anonymization process. As another example, a wide range of different types of machine learning models can be effectively trained using the system metadata generated by the present techniques. In contrast, many conventional model training techniques, including the federated learning technique, train global machine learning models across multiple regions without first effectively anonymizing the data, and as a result, such techniques are limited in term of the supported types of machine learning models. As another example, there is no need to separately verify that the machine learning model(s) trained using the system metadata described herein meet the privacy requirements. In contrast, according to conventional modeling training techniques, the trained machine learning models must separately pass privacy reviews to ensure that the privacy requirements are being met.

As used herein, the term “application” or “enterprise application” refers to any suitable type(s) of web-based application(s), mobile application(s), and/or other application(s) that are provided by an application service provider, particularly those that form part of a suite or package of products/services (or some subset of such suite/package) that is provided by the application service provider to enable users who are associated with an enterprise (e.g., also referred to herein as a particular “customer”) to interact with their corresponding computing systems to perform tasks relating to the enterprise. As a non-limiting example, if the application service provider is Microsoft Corporation, the application(s) described herein may include (but are not limited to) any or all of the applications within the Microsoft 365® suite. Such applications include Microsoft® Viva®, Microsoft® Excel®, Microsoft® Word®, Microsoft® Teams®, Microsoft® PowerPoint®, Microsoft® Outlook®, Microsoft® OneDrive®, Microsoft® Exchange®, and Microsoft® SharePoint® (among others). More generalized examples of suitable application(s) include (but are not limited to) email/communication applications, social networking applications, employee experience applications, calendar applications, word processing applications, spreadsheet applications, presentation applications, and the like. In other words, the techniques described herein may be implemented within the context of a broad range of web-based applications, mobile applications, and/or additional applications/services, particularly those that are utilized for enterprise-related tasks.

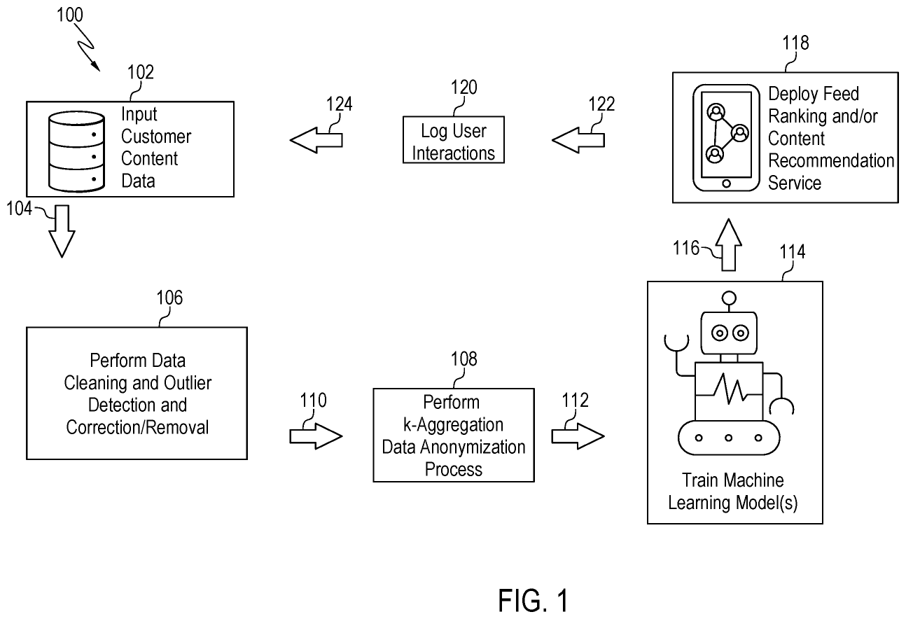

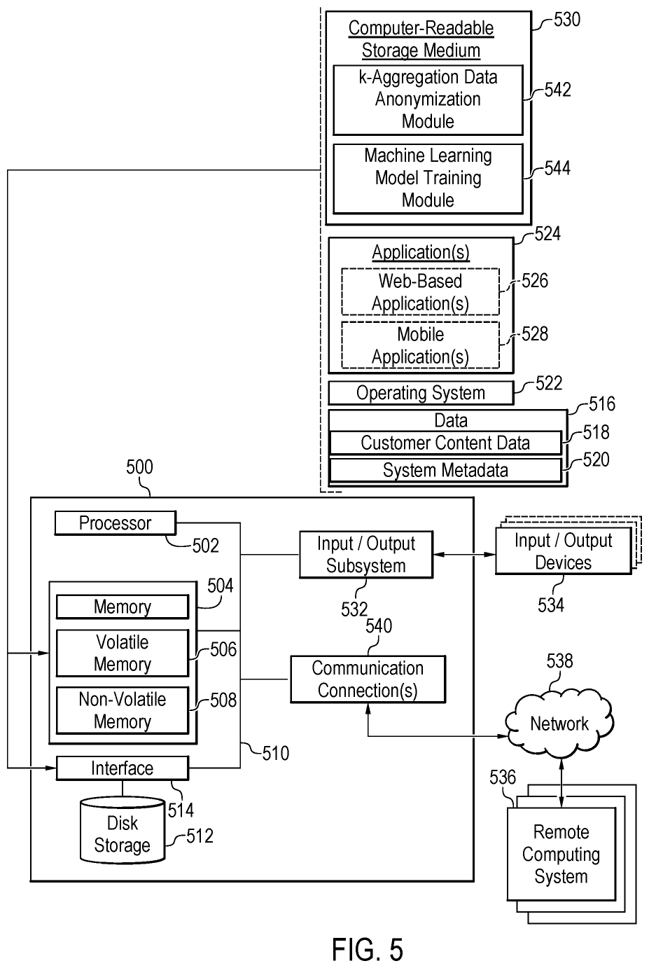

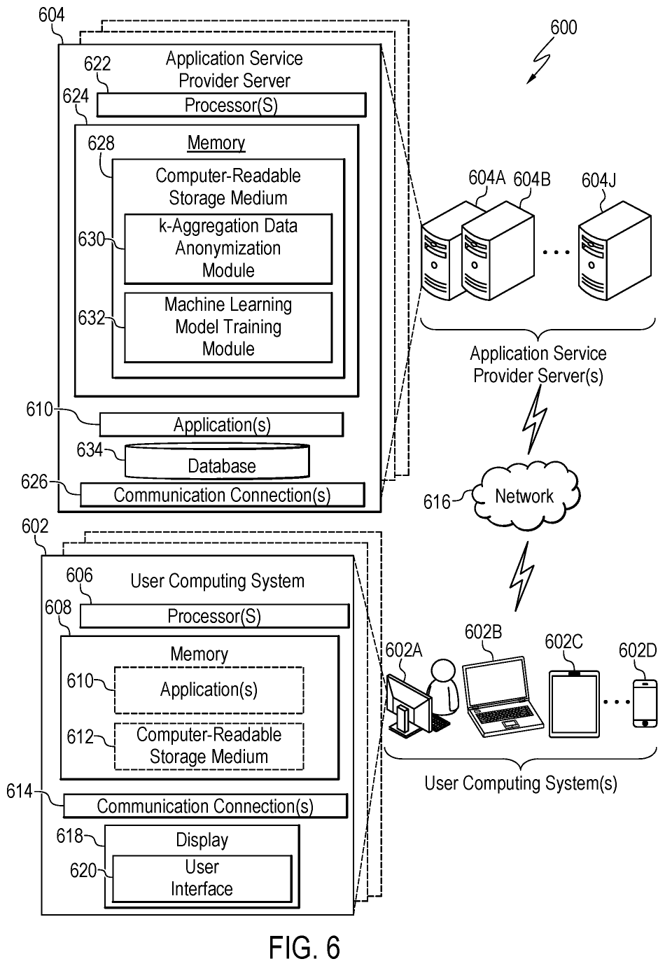

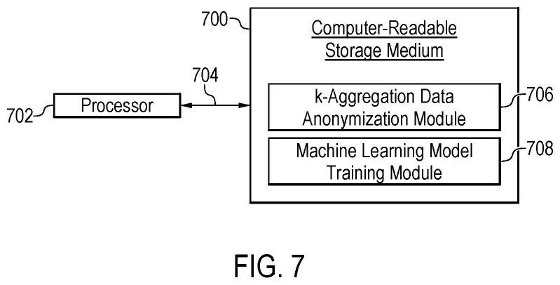

Turning now to a detailed description of the drawings, FIG. 1 is a simplified process flow diagram of a method for utilizing the k-aggregation data anonymization process described herein to generate system metadata suitable for training one or more machine learning models that provide feed ranking and/or content recommendation service(s), for example. The method 100 is executed via one or more computing systems, such as the exemplary computing system described with respect to FIG. 5. In particular, in various embodiments, the computing system(s) implementing the method 100 include one or more computing system(s) or server(s) that are run by an application service provider that provides for the execution of one or more enterprise applications on remote user computing systems. The computing system(s)/server(s) include one or more processors and one or more computer-readable storage media including computer-executable instructions that, when executed by the processor(s), cause the processor(s) to perform the blocks of the method 100. An exemplary embodiment of such computer-readable storage media is described with respect to FIG. 7. Moreover, in various embodiments, the method 100 is executed within the context of a network environment including one or more application service provider computing system(s)/server(s), as described further with respect to the exemplary network environment of FIG. 6.

The method 100 begins at block 102 with the input of customer content data, as indicated by arrow 104. In various embodiments, the customer content data correspond, at least in part, to user interactions with feed ranking and/or content recommendation services/tools provided by one or more enterprise applications offered by the application service provider, as described further with respect to blocks 118 and 120. Moreover, the customer content data correspond to multiple different enterprises that utilize the enterprise application(s) (where each enterprise is a separate customer or tenant of the application service provider), with each user (and, thus, each user interaction) being associated with a particular enterprise. For this reason, when the customer content data are initially input to the method 100 at block 102, boundaries are maintained between the different enterprises (and associated users) such that the aforementioned privacy requirements are satisfied.

At block 106, data cleaning and outlier detection and correction/removal are performed to prepare the customer content data to be input to a k-aggregation data anonymization process at block 108, as indicated by arrow 110. As will be appreciated by those skilled in the art, the data cleaning may include correcting or removing corrupted, incorrectly-formatted, duplicate, irrelevant, and/or incomplete data. Moreover, the outlier detection and correction or removal may be performed using any suitable technique, such as, for example, a distance-based technique for detecting data samples that are far from the center or median point or a statistical technique for detecting data samples that are located on the high side and the low side of the distribution.

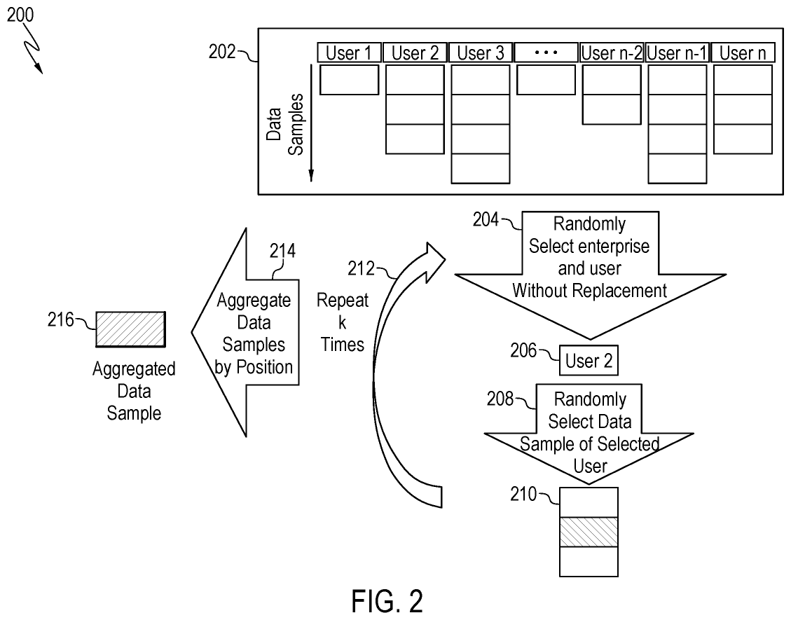

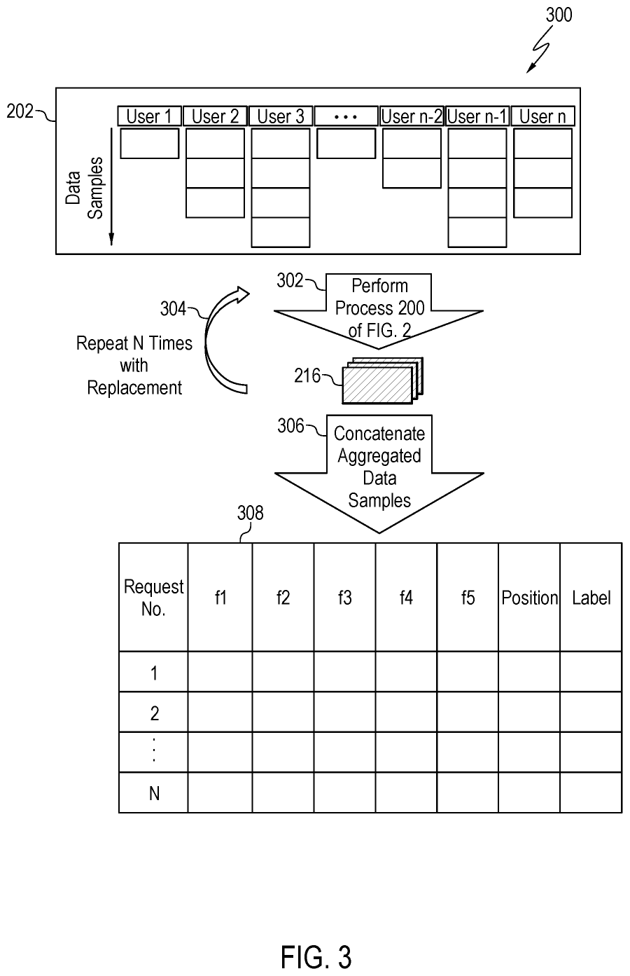

At block 108, the k-aggregation data anonymization process described herein is performed to transform the customer content data into an anonymized dataset that is classified as system metadata. According to embodiments described herein, the k-aggregation data anonymization process includes performing an aggregated data sample generation process on multiple data samples from the customer content data (as described further with respect to FIG. 2), as well as performing an anonymized dataset generation process on the generated aggregated data samples (as described further with respect to FIG. 3).

As indicated by arrow 112, the resulting anonymized dataset is then input to a machine learning model training process at block 114. Specifically, at block 114, the anonymized dataset output from block 108 is utilized to train one or more machine learning models for performing feed ranking and/or content recommendation. Such machine learning model(s) may include, but are not limited to, one or more tree-based model(s), one or more deep learning-based model(s), one or more k-nearest neighbor-based model(s), and/or one or more reinforcement learning-based model(s). The resulting machine learning model(s) are then utilized by one or more enterprise applications, as indicated by arrow 116, to deploy corresponding feed ranking and/or content recommendation service(s)/tool(s) at block 118. Moreover, as enterprise users from various enterprises utilize such service(s)/tool(s), the resulting user interactions are logged at block 120, as indicated by arrow 122, and then the data corresponding to such user interactions are provided as additional customer content data that can be used to perform the method 100, as indicated by arrow 124.

The block diagram of FIG. 1 is not intended to indicate that the blocks of the method 100 are to be executed in any particular order, or that all of the blocks of the method 100 are to be included in every case. Moreover, any number of additional blocks may be included within the method 100, depending on the details of the specific implementation. For example, those skilled in the art will appreciate that the techniques described herein are not limited to the feed ranking and content recommendation embodiment described with respect to FIG. 1 but, rather, may be utilized to train any suitable type(s) of machine learning model(s) for performing any suitable type(s) of enterprise-related task(s).

FIG. 2 is a simplified schematic view depicting a process 200 for generating aggregated data samples via k-aggregation. As shown in FIG. 2, customer content data including data samples 202 from multiple enterprise users (i.e., User 1, User 2, User 3, . . . . User n−2, User n−1, and User n) are input to the process 200, where the enterprise users are associated with multiple enterprises that utilize the enterprise application(s) provided by the application service provider. In various embodiments, each data sample includes one or more numeric values, which may relate to usage data associated with the utilization of one or more feed ranking and/or content recommendation services/tools corresponding to the enterprise application(s), for example. Moreover, in various embodiments, the data samples 202 have undergone data cleaning and outlier detection and correction/removal and have been sorted based on user and position, as shown in FIG. 2.

As indicated by arrow 204, an enterprise is randomly selected from the group of enterprises that are represented by the data samples. In addition, as also indicated by arrow 204, a user is randomly selected, where the selected user is associated with the selected enterprise. In particular, according to the embodiment shown in FIG. 2, User 2 is randomly selected at block 206. According to embodiments described herein, this random enterprise and user selection is performed without replacement, where the term “without replacement” in this context means that, once a particular user has been selected, that user and the enterprise associated with the user cannot be selected again in the next iteration (meaning that other users associated with the same enterprise are also disqualified from selection).

As indicated by arrow 208, a data sample 210 of the selected user is then randomly selected, where the selected data sample may include any number of positions. As indicated by arrow 212, the steps indicated by arrows 204 and 208 are then repeated k times, where the value of k is not limited to a specific number but may be equal to 4, 5, or 6 in some exemplary implementations. More specifically, the iterative loop represented by arrow 212 includes randomly selecting an enterprise and an associated user (without replacement), randomly selecting a data sample corresponding to the selected user, and saving the corresponding data sample, with this process being repeated k times. Moreover, in some embodiments, the value of k is determined according to an L-curve approach in which the distance between the original dataset and the anonymized dataset is plotted for different values of k and the optimal value of k is then selected based on the resulting L-curve.

The resulting collection of selected data samples are then aggregated by position using an aggregation function, as indicated by arrow 214. In various embodiments, this includes calculating the mean or the median of the data samples based on position, randomly selecting a data sample to represent the data samples based on position (e.g., via a T-closeness function), or utilizing any other suitable type of aggregation function that is capable of aggregating the data samples by position. The resulting output from the process 200 is an aggregated data sample 216 that represents a combination of data from k different users associated with k different enterprises.

FIG. 3 is a simplified schematic view depicting a process 300 for generating an anonymized dataset that is classified as system metadata using aggregated data samples generated according to the process 200 of FIG. 2. Like numbered items are as described with respect to FIG. 2. As shown in FIG. 3, the input to the process 300 is the same as the input to the process 200 of FIG. 2, specifically, the customer content data including the data samples 202 from multiple enterprise users.

As indicated by arrows 302 and 304, the first step of the process 300 is to repeat the process 200 of FIG. 2 N times with replacement, where the term “with replacement” in this context means that the same users and the same data samples are available for random selection in each iteration of the loop. Moreover, it should be noted that the value of N is not limited to any particular number but may be equal to 250, 500, 750, or 1000 in some exemplary implementations. In some embodiments, the value of N may be set to the number of samples in the original dataset, for example.

As indicated by arrow 306, the resulting N aggregated data samples output from the process 200 of FIG. 2 are then concatenated (or stacked), thus generating an anonymized dataset 308 of size N. As shown in FIG. 3, the anonymized dataset 308 may be represented as a data table including N data samples. Moreover, the data within the resulting anonymized dataset 308 no longer relate to any particular user or enterprise and, therefore, the anonymized dataset 308 meets the relevant singling-out, linkability, and inference requirements. As a result, such data are classified as system metadata that may be freely utilized to train machine learning models that cross regions and have relatively long retention periods.

Those skilled in the art will appreciate that the exemplary implementations depicted in FIGS. 2 and 3 are for illustrative purposes only. In practice, the techniques described herein may be implemented in any other suitable manner, depending on the details of the particular implementation.

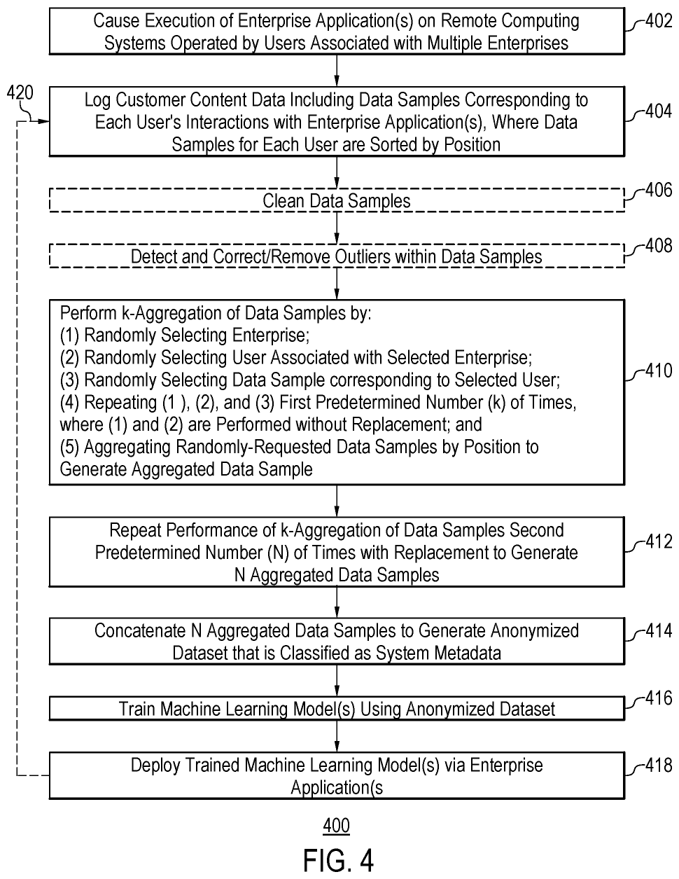

FIG. 4 is a process flow diagram of an exemplary method 400 for transforming customer content data to anonymized system metadata according to embodiments described herein. The method 400 is executed via one or more computing systems, such as the exemplary computing system described with respect to FIG. 5. In particular, in various embodiments, the computing system(s) implementing the method 400 include one or more computing system(s) or server(s) that are run by an application service provider that provides for the execution of one or more applications on remote user computing systems. The computing system(s)/server(s) include one or more processors and one or more computer-readable storage media including computer-executable instructions that, when executed by the processor(s), cause the processor(s) to perform the blocks of the method 400. An exemplary embodiment of such computer-readable storage media is described with respect to FIG. 7. Moreover, in various embodiments, the method 400 is executed within the context of a network environment including one or more application service provider computing system(s)/server(s), as described further with respect to the exemplary network environment of FIG. 6.

The method 400 begins at block 402, at which one or more enterprise applications are caused to be executed on remote computing systems operated by users associated with multiple enterprises. At block 404, customer content data including data samples corresponding to each user's interactions with the enterprise application are logged, where the data samples for each user are sorted by position, as described herein. In various embodiments, each data sample includes one or more numeric values associated with interaction(s) of one of the users with the enterprise application via a corresponding one of the remote computing systems. At optional blocks 406 and 408, the data samples are then prepared for the remainder of the method 400 by cleaning the data samples and then detecting and removing/correcting outliers within the data samples, respectively, as described with respect to the method 100 of FIG. 1.

At block 410, k-aggregation of the data samples is performed by: (1) randomly selecting a specific enterprise from the list of enterprises represented by the data samples; (2) randomly selecting a user that is associated with the selected enterprise; (3) randomly selecting a data sample corresponding to the selected user; (4) repeating steps (1), (2), and (3) a first predetermined number (k) of times (where k may be equal to, but is not limited to, a whole number that is between 4 and 6, inclusive), where steps (1) and (2) are performed without replacement; and (5) aggregating the randomly-requested data samples by position to generate an aggregated data sample, as described with respect to the process 200 of FIG. 2. In some embodiments, step (4) includes calculating the mean of the randomly-requested data samples in each position, although any other suitable aggregation function can alternatively be utilized. At block 412, the k-aggregation of the data samples (i.e., the steps of block 410) are repeated a second predetermined number (N) of times with replacement (where N may be equal to, but is not limited to, a whole number that is between 250 and 1000, inclusive), as described with respect to the process 300 of FIG. 3. Finally, at block 414, the N aggregated data samples are concatenated to generate an anonymized dataset that is classified as system metadata and meets all the privacy requirements described herein and, thus, can freely cross regions to be utilized for tasks relating to multiple different enterprises. To that end, at block 416, one or more machine learning models are trained using the anonymized dataset; and at block 418, the trained machine learning model(s) are deployed via the enterprise application(s). In various embodiments, this includes utilizing the machine learning model(s) to perform feed ranking and/or content recommendation, for example, via the enterprise application(s). Moreover, as indicated via arrow 420 in FIG. 4, additional customer content data including additional data samples corresponding to each user's interactions with the enterprise application with respect to the feed ranking and/or the content recommendation may be logged, and such additional customer content data may then be utilized during a subsequent iteration of the method 400 (i.e., by combining the additional customer content data with the original customer content data at block 404). Furthermore, due to the system metadata classification of the anonymized dataset, the machine learning model(s) trained using such dataset may be deployed across multiple enterprise applications within a suite of enterprise applications including the enterprise application(s) described with respect to block 402, without regard for privacy boundaries between the different enterprises.

The block diagram of FIG. 4 is not intended to indicate that the blocks of the method 400 are to be executed in any particular order, or that all of the blocks of the method 400 are to be included in every case. Moreover, any number of additional blocks may be included within the method 400, depending on the details of the specific implementation.

FIG. 5 is a block diagram of an exemplary computing system 500 for implementing the techniques described herein. The exemplary computing system 500 includes a processor 502 and a memory 504. The processor 502 may include any suitable type of processing unit or device, such as, for example, a single-core processor, a multi-core processor, a computing cluster, or any number of other configurations. Moreover, the processor 502 may include, for example, an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components, or any combinations thereof, designed to perform the functions described herein.

The memory 504 typically (but not always) includes both volatile memory 506 and non-volatile memory 508. The volatile memory 506 retains or stores information so long as the memory is supplied with power. By contrast, the non-volatile memory 508 is capable of storing (or persisting) information even when a power supply is not available. The volatile memory 506 may include, for example, RAM (e.g., synchronous RAM (SRAM), dynamic RAM (DRAM), synchronous dynamic RAM (SDRAM), and the like) and CPU cache memory. The nonvolatile memory 508 may include, for example, read-only memory (ROM) (e.g., programmable ROM (PROM), electrically programmable ROM (EPROM), electrically erasable ROM (EEROM) or the like), flash memory, nonvolatile random-access memory (RAM), solid-state memory devices, memory storage devices, and/or memory cards.

The processor 502 and the memory 504, as well as other components of the computing system 500, are interconnected by way of a system bus 510. The system bus 510 can be implemented using any suitable bus architecture known to those skilled in the art.

According to the embodiment shown in FIG. 5, the computing system 500 also includes a disk storage 512. The disk storage 512 may include any suitable removable/non-removable, volatile/non-volatile storage component or device. For example, the disk storage 512 may include, but is not limited to, a magnetic disk drive, floppy disk drive, tape drive, Jaz drive, Zip drive, LS-210 drive, flash memory card, memory stick, or the like. In addition, the disk storage 512 may include storage media separately from (or in combination with) other storage media including, but not limited to, an optical disk drive, such as a compact disk ROM device (CD-ROM), CD recordable drive (CD-R Drive), CD rewritable drive (CD-RW Drive) or a digital versatile disk ROM drive (DVD-ROM). To facilitate connection of the disk storage 512 to the system bus 510, a removable or non-removable interface is typically used, such as interface 514 shown in FIG. 5.

In various embodiments, the disk storage 512 and/or the memory 504 function as one or more databases that are used to store data 516 relating to the techniques described herein. Such data 516 may include, but are not limited to, the customer content data 518 and system metadata 520 described herein.

Those skilled in the art will appreciate that FIG. 5 describes software that acts as an intermediary between a user of the computing system 500 and the basic computing resources described with respect to the operating environment of the computing system 500. Such software includes an operating system 522. The operating system 522, which may be stored on the disk storage 512, acts to control and allocate the computing resources of the computing system 500. Moreover, system application(s) 524, including one or more web-based applications 526 and/or one or more mobile applications 528, take advantage of the management of the computing resources by the operating system 522 through one or more program modules stored within a computer-readable storage medium (or media) 530, as described further herein.

The computing system 500 also includes an input/output (I/O) subsystem 532. The I/O subsystem 532 includes a set of hardware, software, and/or firmware components that enable or facilitate inter-communication between the user of the computing system 500 and the processor 502 of the computing system 500. During operation of the computing system 500, the I/O subsystem 532 enables the user to interact with the computing system 500 through one or more I/O devices 534. Such I/O devices 534 may include any number of input devices or channels, such as, for example, one or more touchscreen/haptic input devices, one or more buttons, one or more pointing devices, one or more accessories, one or more audio input devices, and/or one or more video input devices, such as a camera. Furthermore, in some embodiments the one or more input devices or channels connect to the processor 502 through the system bus 510 via one or more interface ports (not shown) integrated within the I/O subsystem 532. Such interface ports may include, for example, a serial port, a parallel port, a game port, and/or a universal serial bus (USB).

In addition, such I/O devices 534 may include any number of output devices or channels, such as, for example, one or more audio output devices, one or more haptic feedback devices, and/or one or more display devices. Such output devices or channels may use some of the same types of ports as the input devices or channels. Thus, for example, a USB port may be used to both provide input to the computing system 500 and to output information from the computing system 500 to a corresponding output device. Moreover, in some embodiments, the one or more output devices or channels are accessible via one or more adapters (not shown) integrated within the I/O subsystem 532.

In various embodiments, the computing system 500 is communicably coupled to any number of remote computing systems 536. The remote computing system(s) 536 may include, for example, one or more personal computers (e.g., desktop computers, laptop computers, or the like), one or more tablets, one or more mobile devices (e.g., mobile phones), one or more network PCs, and/or one or more workstations. As an example, in some embodiments, the computing system 500 is an application service provider server hosting one or more application(s) 524 in a networked environment using logical connections to the remote computing systems 536.

In various embodiments, the remote computing systems 536 are logically connected to the computing system 500 through a network 538 and then connected via a communication connection 540, which may be wireless. The network 538 encompasses wireless communication networks, such as local-area networks (LAN) and wide-area networks (WAN). LAN technologies include Fiber Distributed Data Interface (FDDI), Copper Distributed Data Interface (CDDI), Ethernet, Token Ring, and the like. WAN technologies include, but are not limited to, point-to-point links, circuit switching networks like Integrated Services Digital Networks (ISDN) and variations thereon, packet switching networks, and Digital Subscriber Lines (DSL).

The communication connection 540 includes the hardware/software employed to connect the network 538 to the bus 510. While the communication connection 540 is shown for illustrative clarity as residing inside the computing system 500, it can also be external to the computing system 500. The hardware/software for connection to the network 538 may include, for example, internal and external technologies, such as mobile phone switches, modems including regular telephone grade modems, cable modems and DSL modems, ISDN adapters, and/or Ethernet cards.

As described above, the system applications 524 take advantage of the management of the computing resources by the operating system 522 through one or more program modules stored within the computer-readable storage medium (or media) 530. In some embodiments, the computer-readable storage medium 530 is integral to the computing system 500, in which case it may form part of the memory 504 and/or the disk storage 512. In other embodiments, the computer-readable storage medium 530 is an external device that is connected to the computing system 500 when in use.

In various embodiments, the one or more program modules stored within the computer-readable storage medium 530 include program instructions or code that may be executed by the processor 502 to perform various operations. In various embodiments, such program module(s) include, but are not limited to, a k-aggregation data anonymization module 542 and a machine learning model training module 544 that causes the processor 502 to perform the techniques described herein.

It is to be understood that the block diagram of FIG. 5 is not intended to indicate that the computing system 500 is to include all of the components shown in FIG. 5. Rather, the computing system 500 can include fewer or additional components not illustrated in FIG. 5 (e.g., additional applications, additional modules, additional memory devices, additional network interfaces, etc.). Furthermore, any of the functionalities of the one or more program modules/sub-modules may be partially, or entirely, implemented in hardware and/or in the processor 502. For example, the functionality may be implemented with an application specific integrated circuit, in logic implemented in the processor 502, or in any other device.

FIG. 6 is a block diagram of an exemplary network environment 600 for implementing the techniques described herein. As shown in FIG. 6, the network environment 600 includes one or more user computing systems 602 and one or more application service provider servers 604. Each user computing system 602 includes one or more processors 606 and memory 608 communicably coupled to the processor(s) 606. Each user computing system 602 may be implemented as any type of computing system, including (but not limited to) a personal computer, a laptop computer, a tablet computer, a portable digital assistant (PDA), a mobile phone (e.g., a smart phone), an electronic book (e-book) reader, a game console, a set-top box (STB), a smart television (TV), a portable game player, a portable media player, and so forth. FIG. 6 shows representative user computing systems in the forms of a desktop computer 602A, a laptop computer 602B, a tablet 602C, and a mobile device 602D. However, these are merely examples, and the user computing system(s) 602 described herein may take many other forms.

Each user computing system 602 may include one or more applications 610 (and/or data corresponding to the execution of such application(s) 610) and one or more computer-readable storage media 612 stored in the memory 608, as described with respect to the computing system 500 of FIG. 5, for example. Each user computing system 602 also includes a communication connection 614 by which the user computing system 602 is able to communicate with other devices, including the application service provider server(s) 604, over a network 616. Furthermore, each user computing system 602 includes a display 618, which may be a built-in display or an external display, depending on the particular type of computing system. According to embodiments described herein, the display 618 is configured to surface one or more user interfaces 620 corresponding to the execution of the application(s) 610 on the user computing system 602.

In various embodiments, the application(s) 610 are implemented or hosted by the application service provider server(s) 604, which may be provided as one or more server farms or data centers, for example. As an example, in the embodiment shown in FIG. 6, the application service provider server(s) 604 include servers 604A-J, for example. Moreover, it should be noted that the server components shown in FIG. 6 may each be implemented within any or all of the multiple application service provider servers 604, depending on the details of the particular implementation. Specifically, the application service provider server(s) 604 include one or more processors 622 communicably coupled to memory 624. The memory 624 may include one or more multiple memory devices, depending on the details of the particular implementation. The application service provider server(s) 604 also include one or more communication connections 626 by which the application(s) 610 described herein may be executed or hosted on the user computing system(s) 602 via the network 616. In particular, the application service provider server(s) 604 provide for execution of the application(s) 610 on the user computing system(s) 602 by, for example, surfacing the one or more user interfaces 620 associated with the application(s) 610 on the display 618 corresponding to each user computing system 602.

In various embodiments, the memory 624 includes the application(s) 610 described herein, as well as one or more computer-readable storage media 628. The computer-readable storage medium (or media) 628 includes program instructions or code that may be executed by the processor(s) 622 (and/or the processor(s) 606) to perform various operations. In various embodiments, such program module(s) include, but are not limited to, a k-aggregation data anonymization module 630 and a machine learning model training module 632 that cause the processor(s) 622 to perform operations in accordance with the techniques described herein. The memory 624 further includes a database 634, which may be configured to store (among other data) the customer content data and the system metadata described herein.

It is to be understood that the simplified block diagram of FIG. 6 is not intended to indicate that the network environment 600 is to include all of the components shown in FIG. 6. Rather, the network environment 600 may include different components and/or additional components not illustrated in FIG. 6. For example, in practice, the user computing system(s) 602 and the application service provider server(s) 604 will typically include a number of additional components not depicted in the simplified block diagram of FIG. 6, as described with respect to the computing system 500 of FIG. 5, for example.

FIG. 7 is a block diagram of an exemplary computer-readable storage medium (or media) 700 for implementing the techniques described herein. In various embodiments, the computer-readable storage medium 700 is accessed by one or more processor(s) 702 over one or more computer interconnects 704. For example, in some embodiments, the computer-readable storage medium 700 is the same as, or similar to, the computer-readable storage medium described with respect to the computing system 500 of FIG. 5 and/or the network environment 600 of FIG. 6.

In various embodiments, the computer-readable storage medium 700 includes code (i.e., computer-executable instructions) to direct the processor(s) 702 to perform the operations of the present techniques. Such code may be stored within the computer-readable storage medium 700 in the form of program modules, where each module includes a set of computer-executable instructions that, when executed by the processor(s) 702, cause the processor(s) 702 to perform a corresponding set of operations. In particular, as described herein, the computer-readable storage medium 700 includes (but is not limited to) a k-aggregation data anonymization module 706 and a machine learning model training module 708 that direct the processor(s) 702 to perform at least a portion of the techniques described herein.

Moreover, those skilled in the art will appreciate that any suitable number of the modules shown in FIG. 7 may be included within the computer-readable storage medium (or media) 700. Furthermore, any number of additional modules/sub-modules not shown in FIG. 7 may be included within the computer-readable storage medium (or media) 700, depending on the details of the specific implementation.

It should be noted that some components shown in the figures are described herein in the context of one or more structural components, referred to as functionalities, modules, features, elements, etc. However, the components shown in the figures can be implemented in any manner, for example, by software, hardware (e.g., discrete logic components, etc.), firmware, and so on, or any combination of these implementations. In one embodiment, the various components may reflect the use of corresponding components in an actual implementation. In other embodiments, any single component illustrated in the figures may be implemented by a number of actual components. The depiction of any two or more separate components in the figures may reflect different functions performed by a single actual component.

Other figures describe the concepts in flowchart form. In this form, certain operations are described as constituting distinct blocks performed in a certain order. Such implementations are exemplary and non-limiting. Certain blocks described herein can be grouped together and performed in a single operation, certain blocks can be broken apart into plural component blocks, and certain blocks can be performed in an order that differs from that which is illustrated herein, including a parallel manner of performing the blocks. The blocks shown in the flowcharts can be implemented by software, hardware, firmware, and the like, or any combination of these implementations. As used herein, hardware may include computing systems, discrete logic components, such as application specific integrated circuits (ASICs), and the like, as well as any combinations thereof.

The term “logic” encompasses any functionality for performing a task. For instance, each operation illustrated in the flowcharts corresponds to logic for performing that operation. An operation can be performed using software, hardware, firmware, etc., or any combinations thereof.

As utilized herein, the terms “component,” “system,” and the like are intended to refer to a computer-related entity, either hardware, software (e.g., in execution), and/or firmware, or a combination thereof. For example, a component can be a process running on a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any tangible, computer-readable storage medium.

Moreover, as used herein, the term “computer-readable storage medium (or media)” refers to an article of manufacture. In general, computer-readable storage media are used to host, store and/or reproduce computer-executable instructions and data for later retrieval and/or execution. When the computer-executable instructions that are hosted or stored on the computer-readable storage media are executed by a processor of a computing system, the execution thereof causes, configures and/or adapts the executing computing system to carry out various steps, processes, routines, methods and/or functionalities, including the steps, processes, routines, methods, and/or functionalities described herein. Examples of computer-readable storage media include, but are not limited to, optical storage media (such as Blu-ray discs, digital video discs (DVDs), compact discs (CDs), optical disc cartridges, and the like), magnetic storage media (such as hard disk drives, floppy disks, magnetic tape, and the like), memory storage devices (such as random access memory (RAM), read-only memory (ROM), memory cards, thumb drives, and the like), and cloud storage (such as online storage services). Computer-readable storage media may deliver computer-executable instructions to a computing system for execution via various transmission means and mediums, including carrier waves and/or propagated signals. However, for purposes of this disclosure, the term “computer-readable storage medium (or media)” refers specifically to non-transitory forms of computer-readable storage media and expressly excludes carrier waves and/or propagated signals.

The present techniques may be susceptible to various modifications and alternative forms, including (but not limited to) those described in the following examples:
Example 1 is a method for transforming customer content data to anonymized system metadata, where the method is implemented via a computing system including a processor, and where the method includes: causing execution of an enterprise application on remote computing systems operated by users associated with multiple enterprises; logging customer content data including data samples corresponding to each user's interactions with the enterprise application, where the data samples for each user are sorted by position; performing k-aggregation of the data samples by: randomly selecting an enterprise from the multiple enterprise; randomly selecting a user associated with the selected enterprise from the users of the remote computing systems; randomly selecting a data sample corresponding to the selected user; repeating the random selection of the enterprise, the random selection of the user, and the random selection of the data sample a first predetermined number (k) of times, where the repetition of the random selection of the enterprise and the random selection of the user is performed without replacement; and aggregating the randomly-requested data samples by position to generate an aggregated data sample; repeating the performance of the k-aggregation of the data samples a second predetermined number (N) of times with replacement to generate N aggregated data samples; concatenating the N aggregated data samples to generate an anonymized dataset that is classified as system metadata; training a machine learning model using the anonymized dataset; and deploying the trained machine learning model via the enterprise application.
Example 2 includes the method of example 1, including or excluding optional features. In this example, deploying the trained machine learning model via the enterprise application includes utilizing the trained machine learning model to perform at least one of feed ranking or content recommendation via the enterprise application.
Example 3 includes the method of example 2, including or excluding optional features. In this example, the method includes deploying the trained machine learning model across multiple enterprise applications within a suite of enterprise applications including the enterprise application, without regard for privacy boundaries between different enterprises.
Example 4 includes the method of example 2, including or excluding optional features. In this example, the method includes logging additional customer content data including additional data samples corresponding to each user's interactions with the enterprise application with respect to the at least one of the feed ranking or the content recommendation; and utilizing the additional customer content data during a subsequent iteration of the method.
Example 5 includes the method of any one of examples 1 to 4, including or excluding optional features. In this example, the method includes, prior to performing the k-aggregation of the data samples: cleaning the data samples; detecting outliers within the cleaned data samples; and performing correction or removal of each detected outlier.
Example 6 includes the method of any one of examples 1 to 5, including or excluding optional features. In this example, the method includes aggregating the randomly-requested data samples by calculating a mean of the randomly-requested data samples in each position.
Example 7 includes the method of any one of examples 1 to 6, including or excluding optional features. In this example, each data sample includes at least one numeric value associated with an interaction of one of the users with the enterprise application via a corresponding one of the remote computing systems.
Example 8 includes the method of any one of examples 1 to 7, including or excluding optional features. In this example, the first predetermined number is equal to a whole number that is between 4 and 6, inclusive; and where the second predetermined number is equal to a whole number that is between 250 and 1000, inclusive.
Example 9 is an application service provider server, including: a processor; an enterprise application; a communication connection for connecting remote computing systems to the application service provider server via a network, where the remote computing systems are operated by users associated with multiple enterprises; and a computer-readable storage medium operatively coupled to the processor, the computer-readable storage medium including computer-executable instructions that, when executed by the processor, cause the processor to: cause execution of the enterprise application on the remote computing systems; log customer content data including data samples corresponding to each user's interactions with the enterprise application, where the data samples for each user are sorted by position; perform k-aggregation of the data samples by: randomly selecting an enterprise from the multiple enterprise; randomly selecting a user associated with the selected enterprise from the users of the remote computing systems; randomly selecting a data sample corresponding to the selected user; repeating the random selection of the enterprise, the random selection of the user, and the random selection of the data sample a first predetermined number (k) of times, where the repetition of the random selection of the enterprise and the random selection of the user is performed without replacement; and aggregating the randomly-requested data samples by position to generate an aggregated data sample; repeat the performance of the k-aggregation of the data samples a second predetermined number (N) of times with replacement to generate N aggregated data samples; concatenate the N aggregated data samples to generate an anonymized dataset that is classified as system metadata; train a machine learning model using the anonymized dataset; and deploy the trained machine learning model via the enterprise application.
Example 10 includes the application service provider server of example 9, including or excluding optional features. In this example, the computer-readable storage medium includes computer-executable instructions that, when executed by the processor, cause the processor to deploy the trained machine learning model via the enterprise application by utilizing the trained machine learning model to perform at least one of feed ranking or content recommendation via the enterprise application.
Example 11 includes the application service provider server of example 10, including or excluding optional features. In this example, the computer-readable storage medium includes computer-executable instructions that, when executed by the processor, cause the processor to deploy the trained machine learning model across multiple enterprise applications within a suite of enterprise applications including the enterprise application, without regard for privacy boundaries between different enterprises.
Example 12 includes the application service provider server of example 10, including or excluding optional features. In this example, the computer-readable storage medium includes computer-executable instructions that, when executed by the processor, cause the processor to: log additional customer content data including additional data samples corresponding to each user's interactions with the enterprise application with respect to the at least one of the feed ranking or the content recommendation; and combine the additional data samples with the data samples of claim 9.
Example 13 includes the application service provider server of any one of examples 9 to 12, including or excluding optional features. In this example, the computer-readable storage medium includes computer-executable instructions that, when executed by the processor, cause the processor to, prior to performing the k-aggregation of the data samples: clean the data samples; detect outliers within the cleaned data samples; and perform correction or removal of each detected outlier.
Example 14 includes the application service provider server of any one of examples 9 to 13, including or excluding optional features. In this example, the computer-readable storage medium includes computer-executable instructions that, when executed by the processor, cause the processor to aggregate the randomly-requested data samples by calculating a mean of the randomly-requested data samples in each position.
Example 15 includes the application service provider server of any one of examples 9 to 14, including or excluding optional features. In this example, each data sample includes at least one numeric value associated with an interaction of one of the users with the enterprise application via a corresponding one of the remote computing systems.
Example 16 is computer-readable storage medium including computer-executable instructions that, when executed by a processor, cause the processor to: cause execution of an enterprise application on remote computing systems operated by users associated with multiple enterprises; log customer content data including data samples corresponding to each user's interactions with the enterprise application, where the data samples for each user are sorted by position; perform k-aggregation of the data samples by: randomly selecting an enterprise from the multiple enterprise; randomly selecting a user associated with the selected enterprise from the users of the remote computing systems; randomly selecting a data sample corresponding to the selected user; repeating the random selection of the enterprise, the random selection of the user, and the random selection of the data sample a first predetermined number (k) of times, where the repetition of the random selection of the enterprise and the random selection of the user is performed without replacement; and aggregating the randomly-requested data samples by position to generate an aggregated data sample; repeat the performance of the k-aggregation of the data samples a second predetermined number (N) of times with replacement to generate N aggregated data samples; concatenate the N aggregated data samples to generate an anonymized dataset that is classified as system metadata; train a machine learning model using the anonymized dataset; and deploy the trained machine learning model via the enterprise application.
Example 17 includes the computer-readable storage medium of example 16, including or excluding optional features. In this example, the computer-executable instructions, when executed by the processor, cause the processor to deploy the trained machine learning model via the enterprise application by utilizing the trained machine learning model to perform at least one of feed ranking or content recommendation via the enterprise application.
Example 18 includes the computer-readable storage medium of example 16 or 17, including or excluding optional features. In this example, the computer-executable instructions, when executed by the processor, cause the processor to deploy the trained machine learning model across multiple enterprise applications within a suite of enterprise applications including the enterprise application, without regard for privacy boundaries between different enterprises.
Example 19 includes the computer-readable storage medium of any one of examples 16 to 18, including or excluding optional features. In this example, the computer-executable instructions, when executed by the processor, cause the processor to, prior to performing the k-aggregation of the data samples: clean the data samples; detect outliers within the cleaned data samples; and perform correction or removal of each detected outlier.
Example 20 includes the computer-readable storage medium of any one of examples 16 to 19, including or excluding optional features. In this example, the computer-executable instructions, when executed by the processor, cause the processor to aggregate the randomly-requested data samples by calculating a mean of the randomly-requested data samples in each position.

It should be noted that, while the methods and processes described herein are generally expressed in regard to discrete steps, these steps should be viewed as being logical in nature and may or may not correspond to any specific actual and/or discrete steps of a given implementation. In addition, the order in which these steps are presented in the various methods and processes, unless otherwise indicated, should not be construed as the only order in which the steps may be carried out. Moreover, in some instances, some of these steps may be combined and/or omitted. Those skilled in the art will recognize that the logical presentation of steps is sufficiently instructive to carry out aspects of the claimed subject matter irrespective of any particular development or coding language in which the logical instructions/steps are encoded.

Of course, while the methods and processes described herein include various novel features of the disclosed subject matter, other steps (not listed) may also be carried out in the execution of the subject matter set forth in these methods and processes. Those skilled in the art will appreciate that the logical steps of these methods and processes may be combined together or split into additional steps. Steps of the above-described methods and processes may be carried out in parallel or in series. Often, but not exclusively, the functionality of a particular method or process is embodied in software (e.g., applications, system services, libraries, and the like) that is executed on one or more processors of computing systems. Additionally, in various embodiments, all or some of the various methods and processes may also be embodied in executable hardware modules including, but not limited to, system on chips (SoC's), codecs, specially designed processors and/or logic circuits, and the like, on a computing system.

As suggested above, each method or process described herein is typically embodied within computer-executable instruction (or code) modules including individual routines, functions, looping structures, selectors, and switches (such as if-then and if-then-else statements), assignments, arithmetic computations, and the like, that, in execution, configure a computing system to operate in accordance with the particular method or process. However, as suggested above, the exact implementation in executable statement of each of the methods or processes is based on various implementation configurations and decisions, including programming languages, compilers, target processors, operating environments, and the linking or binding operation. Those skilled in the art will readily appreciate that the logical steps identified in these methods and processes may be implemented in any number of ways and, thus, the logical descriptions set forth above are sufficiently enabling to achieve similar results.

While various novel aspects of the disclosed subject matter have been described, it should be appreciated that these aspects are exemplary and should not be construed as limiting. Variations and alterations to the various aspects may be made without departing from the scope of the disclosed subject matter.

In particular and in regard to the various functions performed by the above described components, devices, circuits, systems and the like, the terms used to describe such components are intended to correspond, unless otherwise indicated, to any component which performs the specified function of the described component, e.g., a functional equivalent, even though not structurally equivalent to the disclosed structure, which performs the function in the herein illustrated exemplary aspects of the claimed subject matter. In this regard, it will also be recognized that the innovation includes a system as well as a computer-readable storage media having computer-executable instructions for performing the acts and events of the various methods of the claimed subject matter.

There are multiple ways of implementing the claimed subject matter, e.g., an appropriate API, tool kit, driver code, operating system, control, standalone or downloadable software object, etc., which enables applications and services to use the techniques described herein. The claimed subject matter contemplates the use from the standpoint of an API (or other software object), as well as from a software or hardware object that operates according to the techniques set forth herein. Thus, various implementations of the claimed subject matter described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and additional components, and according to various permutations and combinations of the foregoing. Sub-components can also be implemented as components communicatively coupled to other components rather than included within parent components (hierarchical).

Additionally, it can be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the claimed subject matter may have been disclosed with respect to one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A method for transforming customer content data to anonymized system metadata, wherein the method is implemented via a computing system comprising a processor, and wherein the method comprises:
causing execution of an enterprise application on remote computing systems operated by users associated with multiple enterprises;
logging customer content data comprising data samples corresponding to each user's interactions with the enterprise application, wherein the data samples for each user are sorted by position;
performing k-aggregation of the data samples by:
randomly selecting an enterprise from the multiple enterprise;
randomly selecting a user associated with the selected enterprise from the users of the remote computing systems;
randomly selecting a data sample corresponding to the selected user;
repeating the random selection of the enterprise, the random selection of the user, and the random selection of the data sample a first predetermined number (k) of times, wherein the repetition of the random selection of the enterprise and the random selection of the user is performed without replacement; and
aggregating the randomly-requested data samples by position to generate an aggregated data sample;
repeating the performance of the k-aggregation of the data samples a second predetermined number (N) of times with replacement to generate N aggregated data samples;
concatenating the N aggregated data samples to generate an anonymized dataset that is classified as system metadata;
training a machine learning model using the anonymized dataset; and
deploying the trained machine learning model via the enterprise application.

2. The method of claim 1, deploying the trained machine learning model via the enterprise application comprises utilizing the trained machine learning model to perform at least one of feed ranking or content recommendation via the enterprise application.

3. The method of claim 2, comprising deploying the trained machine learning model across multiple enterprise applications within a suite of enterprise applications comprising the enterprise application, without regard for privacy boundaries between different enterprises.

4. The method of claim 2, comprising:
logging additional customer content data comprising additional data samples corresponding to each user's interactions with the enterprise application with respect to the at least one of the feed ranking or the content recommendation; and
utilizing the additional customer content data during a subsequent iteration of the method.

5. The method of claim 1, comprising, prior to performing the k-aggregation of the data samples:
cleaning the data samples;
detecting outliers within the cleaned data samples; and
performing correction or removal of each detected outlier.

6. The method of claim 1, comprising aggregating the randomly-requested data samples by calculating a mean of the randomly-requested data samples in each position.

7. The method of claim 1, wherein each data sample comprises at least one numeric value associated with an interaction of one of the users with the enterprise application via a corresponding one of the remote computing systems.

8. The method of claim 1, wherein the first predetermined number is equal to a whole number that is between 4 and 6, inclusive; and wherein the second predetermined number is equal to a whole number that is between 250 and 1000, inclusive.

9. An application service provider server, comprising:
a processor;
an enterprise application;
a communication connection for connecting remote computing systems to the application service provider server via a network, wherein the remote computing systems are operated by users associated with multiple enterprises; and
a computer-readable storage medium operatively coupled to the processor, the computer-readable storage medium comprising computer-executable instructions that, when executed by the processor, cause the processor to:
cause execution of the enterprise application on the remote computing systems;
log customer content data comprising data samples corresponding to each user's interactions with the enterprise application, wherein the data samples for each user are sorted by position;
perform k-aggregation of the data samples by:
randomly selecting an enterprise from the multiple enterprise;
randomly selecting a user associated with the selected enterprise from the users of the remote computing systems;
randomly selecting a data sample corresponding to the selected user;
repeating the random selection of the enterprise, the random selection of the user, and the random selection of the data sample a first predetermined number (k) of times, wherein the repetition of the random selection of the enterprise and the random selection of the user is performed without replacement; and
aggregating the randomly-requested data samples by position to generate an aggregated data sample;
repeat the performance of the k-aggregation of the data samples a second predetermined number (N) of times with replacement to generate N aggregated data samples;
concatenate the N aggregated data samples to generate an anonymized dataset that is classified as system metadata;
train a machine learning model using the anonymized dataset; and
deploy the trained machine learning model via the enterprise application.

10. The application service provider server of claim 9, wherein the computer-readable storage medium comprises computer-executable instructions that, when executed by the processor, cause the processor to deploy the trained machine learning model via the enterprise application by utilizing the trained machine learning model to perform at least one of feed ranking or content recommendation via the enterprise application.

11. The application service provider server of claim 10, wherein the computer-readable storage medium comprises computer-executable instructions that, when executed by the processor, cause the processor to deploy the trained machine learning model across multiple enterprise applications within a suite of enterprise applications comprising the enterprise application, without regard for privacy boundaries between different enterprises.

12. The application service provider server of claim 10, wherein the computer-readable storage medium comprises computer-executable instructions that, when executed by the processor, cause the processor to:
log additional customer content data comprising additional data samples corresponding to each user's interactions with the enterprise application with respect to the at least one of the feed ranking or the content recommendation; and
combine the additional data samples with the data samples.

13. The application service provider server of claim 9, wherein the computer-readable storage medium comprises computer-executable instructions that, when executed by the processor, cause the processor to, prior to performing the k-aggregation of the data samples:
clean the data samples;
detect outliers within the cleaned data samples; and
perform correction or removal of each detected outlier.

14. The application service provider server of claim 9, wherein the computer-readable storage medium comprises computer-executable instructions that, when executed by the processor, cause the processor to aggregate the randomly-requested data samples by calculating a mean of the randomly-requested data samples in each position.

15. The application service provider server of claim 9, wherein each data sample comprises at least one numeric value associated with an interaction of one of the users with the enterprise application via a corresponding one of the remote computing systems.

16. A computer-readable storage medium comprising computer-executable instructions that, when executed by a processor, cause the processor to:
cause execution of an enterprise application on remote computing systems operated by users associated with multiple enterprises;
log customer content data comprising data samples corresponding to each user's interactions with the enterprise application, wherein the data samples for each user are sorted by position;
perform k-aggregation of the data samples by:
randomly selecting an enterprise from the multiple enterprise;
randomly selecting a user associated with the selected enterprise from the users of the remote computing systems;
randomly selecting a data sample corresponding to the selected user;
repeating the random selection of the enterprise, the random selection of the user, and the random selection of the data sample a first predetermined number (k) of times, wherein the repetition of the random selection of the enterprise and the random selection of the user is performed without replacement; and
aggregating the randomly-requested data samples by position to generate an aggregated data sample;
repeat the performance of the k-aggregation of the data samples a second predetermined number (N) of times with replacement to generate N aggregated data samples;
concatenate the N aggregated data samples to generate an anonymized dataset that is classified as system metadata;
train a machine learning model using the anonymized dataset; and
deploy the trained machine learning model via the enterprise application.

17. The computer-readable storage medium of claim 16, wherein the computer-executable instructions, when executed by the processor, cause the processor to deploy the trained machine learning model via the enterprise application by utilizing the trained machine learning model to perform at least one of feed ranking or content recommendation via the enterprise application.

18. The computer-readable storage medium of claim 16, wherein the computer-executable instructions, when executed by the processor, cause the processor to deploy the trained machine learning model across multiple enterprise applications within a suite of enterprise applications comprising the enterprise application, without regard for privacy boundaries between different enterprises.

19. The computer-readable storage medium of claim 16, wherein the computer-executable instructions, when executed by the processor, cause the processor to, prior to performing the k-aggregation of the data samples:
clean the data samples;
detect outliers within the cleaned data samples; and
perform correction or removal of each detected outlier.

20. The computer-readable storage medium of claim 16, wherein the computer-executable instructions, when executed by the processor, cause the processor to aggregate the randomly-requested data samples by calculating a mean of the randomly-requested data samples in each position.
